(19) United States
(12) Patent Application Publication
(10) Pub. No.: US 2024/0271645 A1
(43) Pub. Date: Aug. 15, 2024

(54) CONNECTING ELEMENT OF TWO COMPONENTS BEING SPACED APART ONE ANOTHER WITH TOLERANCE COMPENSATION FUNCTION AS WELL AS AN INSTALLATION METHOD FOR SAME

(71) Applicant: Böllhoff Verbindungstechnik GmbH, Bielefeld (DE)

(72) Inventors: Heinrich HEINRICHS, Vlotho (DE); Waldemar WEDEL, Bielefeld (DE)

(21) Appl. No.: 18/437,063

(22) Filed: Feb. 8, 2024

(30) Foreign Application Priority Data
Feb. 9, 2023 (DE) 102023103194.5

(51) Int. Cl. F16B 5/02

(52) U.S. Cl. CPC F16B 5/0233

(57) ABSTRACT

A connecting element of two components spaced apart one another with tolerance compensation function comprising the following features: a hollow screw with an outer thread, with which a thread connection to a first component is establishable, which is adjustable by means of at least one drive means of the hollow screw in its longitudinal direction, a nut element which is received in a receiving space of the hollow screw and which comprises a radial inner functional surface so that a form-fit and force-fit connection is establishable with a first connecting end of a connecting bolt, wherein the connecting bolt has a second connecting end, with which a connection to a second component is establishable.

### 1. FIELD OF THE INVENTION

The present invention is related to a connecting element of two components being spaced apart one another with tolerance compensation function. Furthermore, the present invention relates to a connecting method of a first and a second component at a distance to one another with the help of the above-mentioned connecting element.

### 2. BACKGROUND OF THE INVENTION

In the state of the art, different connecting elements or connecting systems, respectively, are known for connecting two components with one another at a fixed distance to one another. US 2017/0051780 A1 for example discloses a first component, in the opening of which a sleeve-like clip is arranged. A retainer of a second component fastens a pin which in terms of its shape is adapted for producing a form-fit connection to the above-mentioned clip. By assembling clip and pin, a connection between these two components is established. The disadvantage of this connecting system is, however, that only an axial connection between the pin and the clip can be established, while tolerances arising in axial and in lateral direction cannot be compensated by means of a correction possibility.

DE 42 24 575 A1 describes a connecting arrangement with automatic tolerance compensation. For this purpose, the connecting arrangement is first fastened to a first component. The second component, which is spaced apart from the first component, is connected to the first component with the help of a threaded bolt by means of the connecting arrangement. During screwing-in the threaded bolt into the connecting arrangement, an automatic tolerance compensation takes place in which an adjustment element compensates the distance between the first and the second component. As soon as the tolerance compensation arrangement has bridged the distance of both components, the threaded bolt is screwed into a fastening receiving thread. This connecting arrangement is laborious in its construction as first of all, the automatic tolerance compensation must be realized by coordinating different threaded connections within the connecting arrangement. Furthermore, not every connection situation allows the use of a threaded bolt which can only be screwed together with the connecting arrangement reliably by using a specific processing time.

DE 10 2007 002 699 A1 describes a fastening assembly which is based on the use of two sleeves which are connected with each other like a telescope. These sleeves are connected to each other by means of an inner and an outer thread in order to be able to bridge a distance between a first and a second component. A connecting threaded bolt extends within the inner sleeve so as to screw the first and the second component together. Accordingly, the telescope-like interacting sleeves can compensate axial tolerances. As the cross-section of the connecting threaded bolt is smaller than the inner diameter of the inner sleeve, a compensation of radial tolerances by means of a relative displacement between threaded bolt and surrounding sleeve is guaranteed.

US 2018/0328390 A1 uses a central bolt having two thread ends being arranged opposite each other and a distance block lying in between in order to fasten two components at a certain distance to one another. The two thread ends each require a corresponding counter thread so as to be able to establish a connection on both sides of the threaded bolt. This is associated with a corresponding constructive effort as well as a processing effort later on. In order to reduce the connection effort at least at one thread end of the central bolt, a connecting sleeve is screwed on one of the threaded ends of the connecting bolt. This connecting sleeve is lockable in a multi-part locking construction of the second component. For this purpose, a locking clip is held in a retaining cage of the second component, in which the sleeve that is screwed on the threaded bolt can be locked. In order to compensate axial tolerances between the two components, the threaded bolt may also be adjusted in the locked threaded sleeve. For this purpose, the threaded sleeve is arranged rotatably in its locking arrangement. Due to the plurality of necessary parts for establishing the connection between the two components which are arranged so that they are spaced apart one another, it becomes clear that this connecting arrangement also requires a correspondingly high installation effort apart from a high production effort.

With regard to the state of the art, it is therefore the object of the present invention to provide an alternative connecting element for two components which are spaced apart one another having a tolerance compensation function.

### 3. SUMMARY OF THE INVENTION

The above object is solved by a connecting element according to the independent claim 1, a connection of two components with the connecting element according to claim 12 as well as a connection method of two components according to claim 13. Advantageous embodiments and further developments result from the following description, the drawings as well as the appending claims.

The present invention discloses a connecting element of two components spaced apart one another with tolerance compensation function. The connecting element comprises the following features: a hollow screw with an outer thread, with which a thread connection to a first component is establishable, which is adjustable by means of at least one drive means of the hollow screw in its longitudinal direction, a nut element which is received in a receiving space of the hollow screw and which comprises a radial inner functional surface so that a form-fit and/or force-fit connection is establishable with a first connecting end of a connecting bolt, the connecting bolt having a second connecting end, with which a connection to a second component is establishable.

The present invention describes a connecting element which connects two components with each other at a fixed distance to each other. With this connecting or fastening of the two components to one another, the connecting element allows the compensation of different tolerances for the purpose of adaptation to an optimal connection. These tolerances are on the one hand axial tolerances which are adjustable by rotating the hollow screw, because the hollow screw is located in a preferably self-grooved thread of the first component. By rotating the hollow screw, the connecting element is displaced in its axial direction—i.e. along its longitudinal axis—into the one or the other direction. Furthermore, the inner cavity of the hollow screw as well as the combination of nut element and connecting bolt arranged in there allows the compensation of lateral tolerances perpendicular to the longitudinal axis of the connecting bolt, as the combination of connecting bolt and nut element establishes a force-fit connection with the hollow screw, preferably during establishing the connection. The position of the force-fit connection may be changed within the available cavity of the hollow screw so that in a plane perpendicular to the longitudinal axis of the connecting bolt, a compensation of lateral tolerances is provided by the connecting element. It is understood that the term force-fit and friction-fit are used synonymously.

The connecting bolt includes a first functional connecting end which enters into a form-fit and/or force-fit connection with the nut element. Depending on the connecting forces to be achieved within the connecting element as well as the available cycle time for generating the connection, the connection out of nut element and connecting bolt can be realized as a quick connector or locking connector or as a thread connection.

Accordingly, as the functional surface, the nut element has an inner thread and the connecting bolt has an outer thread or the nut element has a guiding web that is directed radially to the inside or has cams and the connecting bolt has a curvilinear or straight guide groove or a ramp. It is furthermore preferred that locking webs or locking grooves engaging one another are provided on the nut element and the connecting bolt, which are positioned and assigned to one another at consecutive axial positions.

With regard to the second connecting end of the connecting bolt, it is also preferred that a force-fit and/or form-fit connection with the second component be established. For this purpose, the second component preferably provides an opening which is engaged by the second connecting end of the connecting bolt and fastens there. According to a preferred configuration of the present invention, the second connecting end is configured as a quick connector, e.g. a bayonet connector. Same engages a suitable keyhole in the second component. According to a further preferred configuration, the second connecting end of the connecting bolt has a thread portion which enters into a connection with a matching nut element.

According to a preferred embodiment of the present invention, a first opening of the hollow screw has an opening diameter which is larger than a bolt diameter of the connecting bolt which reaches into the hollow screw, so that the connecting bolt can be displaced within the first opening of the hollow screw for compensating tolerances laterally with respect to its longitudinal axis.

As already mentioned above, the construction of the hollow-cylindrical-like or sleeve-like constructed hollow screw allows a lateral displacement of the connecting bolt with respect to its longitudinal axis within the hollow screw. In this way, lateral or radial tolerances with regard to the longitudinal axis of the connecting bolt as well as the longitudinal axis of the hollow screw can be compensated. As preferably, the connecting bolt is fastened in combination with the nut element at a specific radial position within the hollow screw, the tolerances which are necessary for the connection in the alignment of hollow screw and connecting bolt thus become compensable in order to achieve an optimal quality of the connection.

According to a further preferred configuration of the present invention, the hollow screw has a radial collar at the first opening reaching into the first opening, to which collar the nut element and the connecting bolt are fastenable by means of a joint connection so as to fix a radial position of the connecting bolt within the first opening.

According to a preferred configuration of the present invention, the first component includes a receiving opening for screwing-in the hollow screw. The second component is also equipped with a receiving opening or another suitable construction for establishing a connection to the second end of the connecting bolt. In order to effectively connect these two openings or the first and the second component effectively with each other, alignment tolerances between the first and the second component are not compensated by moving the components but by means of moving or displacing the connecting bolt within the hollow screw.

According to a preferred configuration of the present invention, the connecting bolt is firmly connected with the nut element after having assumed its suitable radial position within the hollow screw. This leads to a preferred clamping or generally to a force-fit connection of nut element and connecting bolt with a radial collar of the hollow screw which projects radially inwardly into the hollow screw. In this way, the connection of nut element and functional bolt is firmly arranged within the hollow screw. The construction of the preferred radial collar provides the possibility that the connecting bolt does not necessarily have to be arranged coaxially to a longitudinal axis of the hollow screw. Rather, a parallel alignment of the connecting bolt to the longitudinal axis of the hollow screw preferably arises at this radial collar due to the use of the radial collar and a force-fit connection between connecting bolt and nut element, so that same preferably lie next to each other in a common imagined plane.

Preferably, the connecting bolt comprises a radially outwardly projecting connecting flange between the first and the second connecting end which supports a force-fit connection with the hollow screw.

According to a preferred configuration of the present invention, a radially outwardly projecting connecting flange is arranged at a connecting bolt. A preferred firm connection between connecting bolt and nut element leads to a force-fit retention of the radial collar of the hollow screw between the connecting flange and the nut element. Same guarantees a fixing of the selected radial position of the connecting bolt within the hollow screw.

It is preferred according to the invention that the connecting flange comprises webs or rips facing the hollow screw which support a connection between hollow screw and connecting bolt in a form-fit manner.

According to a further preferred configuration of the present invention, radially extending webs are provided at the connecting flange at a side facing the hollow screw. These webs project from the plane of the connecting flange. With a preferred force-fit connection with the nut element, this will cause the webs, which project from the connecting flange, to being pressed preferably into the radial collar of the hollow screw or into a further part of the hollow screw at its axial end. A form-fit connection which preferably arises by that forms, according to different preferred configurations, a labyrinth sealing or a rotation locking of the connecting bolt relative to the hollow screw. These two functional alternative configurations of the connecting flange support a better quality of the connection between the first and the second component by means of the inventively preferred connecting element.

In a further preferred configuration of the present invention, a cap-like sealing element is provided at the connecting flange which projects in the direction of the second connecting end so as to seal a connection to a second component.

According to a further preferred configuration of the present invention, a sealing element is provided at the connecting flange. This sealing element is oriented in the direction of the second component in a way that when connecting the second connecting end of the connecting bolt with the second component, a sealing contact between the sealing element and the second component can be established. This contact ensures that preferably, the sealing element around a fastening opening at the second component, in which the connecting bolt engages, circumferentially seals the connection to the connecting element. Preferably, this will guarantee that humidity or dust or similar pollution cannot penetrate through the opening in the second component up to the connecting connection element, as the sealing element shields the opening in the second component in a way that such pollutions accumulate at the sealing element.

In a preferred embodiment, for realizing its sealing function, the sealing element is configured cap-like or pot-like and equipped with an opening in the direction of the second component or in other words, facing away from the hollow screw. In this way, the sealing element opens in the direction of the second connecting end of the connecting bolt. The result of the preferred cap-like or pot-like structure of the sealing element is that similar to a hat brim or a circumferential pot wall, a wall of the sealing element is oriented away from the hollow screw, i.e. in the direction of the second connecting end of the connecting bolt. As according to a preferred configuration, a flexible material is used for the sealing element, e.g. an elastomer, this rim attaches to the second component when being connected, so as to realize the sealing function in this way.

It is also preferred that the connecting bolt includes a drive means adjacent to the first connecting end.

In order to establish a preferred connection between the second connecting end of the connecting bolt and the second component, a drive means for transmitting a preferred torque to the connecting bolt is necessary. According to a preferred configuration of the present invention, this drive means is arranged adjacent to the first connecting end of the connecting bolt. The advantage of this is that the second connecting end of the connecting bolt, which faces away from the hollow screw, is available in a functionally complete manner for establishing the connection with the second component.

Furthermore, the connecting element allows that based on this construction, the connection between the first and the second component can also be established alone with a one-sided accessibility of the connecting location. Thus, the present connecting element can particularly also be used at connection locations of two components that are difficult to access while guaranteeing the required distance between the two components.

According to a further preferred configuration of the present invention, the radial inner functional surface of the nut element and the first connecting end of the connecting bolt form a quick lock, in particular a quarter turn quick lock.

In order to keep a necessary cycle time for establishing the connecting between the two components as low as possible, a quick lock connection is provided between the nut element and the first connecting end of the connecting bolt. Same realizes a force-fit and/or form-fit connection to the hollow screw with low effort so as to be able to subsequently compensate tolerances during the connecting of the two components with the connecting element.

According to a further preferred configuration of the present invention, the first connecting end of the connecting bolt comprises an outer thread and the nut element comprises a matching inner thread for establishing a thread connection.

According to a further preferred configuration of the present invention, the connection between the nut element and the first connecting end of the connecting bolt is provided as a thread connection. This means that the nut element comprises an inner thread and the first connecting end of the connecting bolt comprises a matching outer thread. Such a thread connection realizes in an exemplary comparison with a quick lock connection higher connecting forces which could be necessary depending on the two components to be connected with one another. Compared to a connecting quick lock between the nut element and the first connecting end, a thread connection requires more time when establishing the connection than a locking connection or a bayonet connection.

Preferably, the second connecting end of the connecting bolt forms a quick lock with a connecting opening in a second component, in particular a quarter turn quick lock or a bayonet lock.

According to a further preferred configuration of the present invention, the second connecting end of the connecting bolt is configured as a quick lock. Accordingly, this function of the configuration of the second connecting end of the connecting bolt interacts with an opening in the second component in a way that a loadable, force-fit and/or form-fit connection with the second component can only be established by means of, for example, a quarter turn. With the help of this functional configuration, the cycle time for establishing the connection between the two components can be reduced further. It is certainly also preferred to adapt this connection for the sake of higher connecting forces in a way that for example, a thread connection between the second connecting end of the connecting bolt and the second component at the component opening is established. Accordingly, the second component for example includes an inner thread at the component opening or a welding nut adjacent to the component opening or alternatively a blind rivet nut which was inserted into the component opening of the second component before.

According to another preferred embodiment of the present invention, the hollow screw includes a first and a second drive means which are arranged adjacent to the opposite axial ends, in particular an outer drive means and an inner drive means.

The hollow screw is screwed into an opening of the first component. This pre-positioning of the hollow screw or the connecting element, respectively, can for example be realized in a preparation process of the first component. Accordingly, these preparation processes are often not characterized by a lack in space so that preferably, the hollow screw is screwed into the corresponding opening of the first component via an outer drive feature. A known configuration of an outer drive means is a polygon, e.g. a hexagonal structure.

In order to be able to guarantee a preferred axial tolerance compensation between the first and the second component in producing a connection between the two components, the hollow screw preferably comprises a second drive feature. This second drive feature takes effect when, for example, the outer first drive feature, the above-mentioned polygon is difficult to access or is covered by the established connection. Therefore, it is preferred according to the invention that a drive feature be provided within the hollow screw into which a suitable tool can engage in a form-fit manner. According to a preferred configuration of the present invention, the second drive feature is provided at the axial end of the hollow screw which faces away from the radial collar. By doing so, this second drive feature preferably also supports the one-sided accessibility already mentioned above when establishing a connection between a first and a second component.

Furthermore, the present invention also discloses a connection with the help of the above-described connecting element of a first and a second component which are spaced apart one another.

With the help of the inventively preferred connecting element, a vehicle light is preferably connected with a vehicle chassis or a handle construction with the vehicle body or a seat construction with a vehicle frame or the like. In general, two components are connected to one another which must be arranged and fastened with a specific distance to each other.

The present invention furthermore describes a connecting method of a first and a second component at a distance to one another with the connecting element according to the above-described configurations. The connecting method includes the following steps: screwing-in the hollow screw of the connecting element into a first fastening opening at the first component, fastening the second connecting end of the connecting bolt in a second fastening opening of the second component, with radial tolerances being compensated in an axial alignment of the hollow screw and the connecting bolt, connecting the nut element and the first connecting end of the connecting bolt so that the connecting bolt is fastened to the hollow screw.

Furthermore, the present invention discloses a connecting method of two components with the help of the connecting element. In the course of the connecting method, firstly, the hollow screw is screwed into an opening of the first component, with the opening being prepared for this purpose. For this purpose, the hollow screw preferably comprises a self-grooving and/or self-cutting outer thread which generates a corresponding nut thread in the opening of the first component. As soon as the hollow screw and thus the overall connecting element has been positioned and fastened in the first component, the connecting element is axially positioned within the first component by means of a further rotating of the hollow screw. It is also preferred that this axial positioning is realized at a later point in time, preferably after the connection between the first and the second component has been established.

After that, the first component is suitably arranged opposite to the second component and an opening preferably provided there, in order to be able to establish the connection between the first and the second component by means of the connecting element. For this purpose, the connecting bolt is first of all fastened in the second component by means of the above-mentioned drive feature of the connecting bolt. Next, lateral or radial tolerances, respectively, regarding the longitudinal axis of the connecting bolt are compensated by arranging the connecting bolt in combination with the nut element suitably within the hollow screw. As soon as this suitable radial position of connecting bolt and nut element has been found, the connection between connecting bolt and nut element is established in a force-fit and/or form-fit manner. Due to this established connection, the connecting bolt is fixed in its intended radial position at the preferred radial collar of the hollow screw.

According to a preferred configuration of the connecting method, the following is intended as a further step: rotating the hollow screw in the first component so as to adjust an axial position of the connecting element.

Preferably, the following step takes place: releasing the nut element within the hollow screw, changing a radial position of the connecting bolt compared with the hollow screw and after that, fastening the nut element at the connecting bolt.

During the installation method or the connecting method, respectively, of the first and second component, it is also preferred that certain tolerances be compensated. For example, the hollow screw is rotated by means of the preferred second drive feature so that axial tolerances in the distance between the first and the second component can be changed. In case radial deviations in the alignment of the connection element with regard to the opening of the second component should additionally arise in the connection, these radial tolerances may be adapted or compensated by means of a re-positioning of the connecting bolt.

For this purpose, it is preferred that the nut element be rotated with the help of a suitable tool so that the connection of connecting bolt and nut element releases. After releasing, the position which is suitable for the connection of the connecting bolt may be adjusted anew so as to be able to subsequently re-establish the connection between nut element and connecting bolt. Accordingly, options to correct arising tolerances in axial and in radial direction can be realized by the connecting element when establishing the connection between the first component, but also subsequently.

### 4. SHORT DESCRIPTION OF THE DRAWINGS

The present invention is illustrated based on preferred embodiments illustrated in the accompanying drawings, showing:

FIG. 1 a perspective sectional view of a first preferred embodiment of the inventive connecting element,

FIG. 2 an explosive view of the preferred embodiment of the connecting element according to FIG. 1,

FIG. 3 a perspective view of the inventively preferred hollow screw of the connecting element,

FIG. 4 a further view of the preferred hollow screw according to FIG. 3,

FIG. 5 a perspective view of the preferred connecting bolt of the adjustment element according to FIG. 1,

FIG. 6 a further perspective view of the connecting bolt of FIG. 5,

FIG. 7 a partially perspective sectional view of the nut element according to the preferred configuration of the connecting element according to FIG. 1,

FIG. 8 a further perspective view of the nut element of FIG. 7,

FIG. 9 a further partially perspective sectional view of a preferred configuration of the connecting element,

FIG. 10 the preferred connecting element in a partially perspective sectional view connected with the first component,

FIG. 11 a partial sectional view of a preferred connection of a first and a second component with the help of the inventively preferred connecting element,

FIG. 12 a partial perspective sectional view of a further preferred configuration of the inventive connecting element,

FIG. 13 an explosion view of the connecting element according to FIG. 12,

FIG. 14 a perspective illustration of the preferred connecting bolt according to the preferred embodiment of the connecting element in FIG. 12,

FIG. 15 a perspective view of the preferred nut element of the connecting element according to FIG. 12,

FIG. 16 a partial sectional view of a further preferred configuration of the connecting element,

FIG. 17 a connection of a first and a second component with the help of the inventively preferred connecting element according to FIG. 12,

FIG. 18 a perspective partially sectional view of a further preferred configuration of the inventive connecting element,

FIG. 19 a further preferred configuration of the inventive connecting element,

FIG. 20 a further preferred configuration of the inventive connecting element,

FIG. 21 a perspective view of a further preferred configuration of the connecting element,

FIG. 22 a schematic illustration of an inserting of the inventively preferred connecting element with its hollow screw into the first component,

FIG. 23 a preferred illustration of screwing in the hollow screw of the inventively preferred connecting element into the opening of the first component,

FIG. 24 a preferred configuration of a second component with a keyhole,

FIG. 25 the preferred keyhole of the second component according to FIG. 24 into which the second axial connecting end of the connecting bolt according to a preferred embodiment of the inventive connection element is inserted,

FIG. 26 a preferred configuration of the second axial connecting end of the connecting bolt of the inventively preferred connecting element which is locked in the keyhole of FIG. 24,

FIG. 27 a schematic illustration of an adjustment of a radial position of nut element and connecting bolt within a cavity of the hollow screw,

FIG. 28 a further preferred illustration of the adjustment of a radial position of nut element and connecting bolt at the radial collar of the hollow screw of the inventively preferred connecting element,

FIG. 29 a perspective view of a preferred connection of a first and a second component with the inventively preferred connecting element,

FIG. 30 a flow chart of a preferred embodiment of the installation method for establishing a connection between the first and the second component with the help of the connecting element.

### 5. DETAILED DESCRIPTION OF PREFERRED EMBODIMENTS

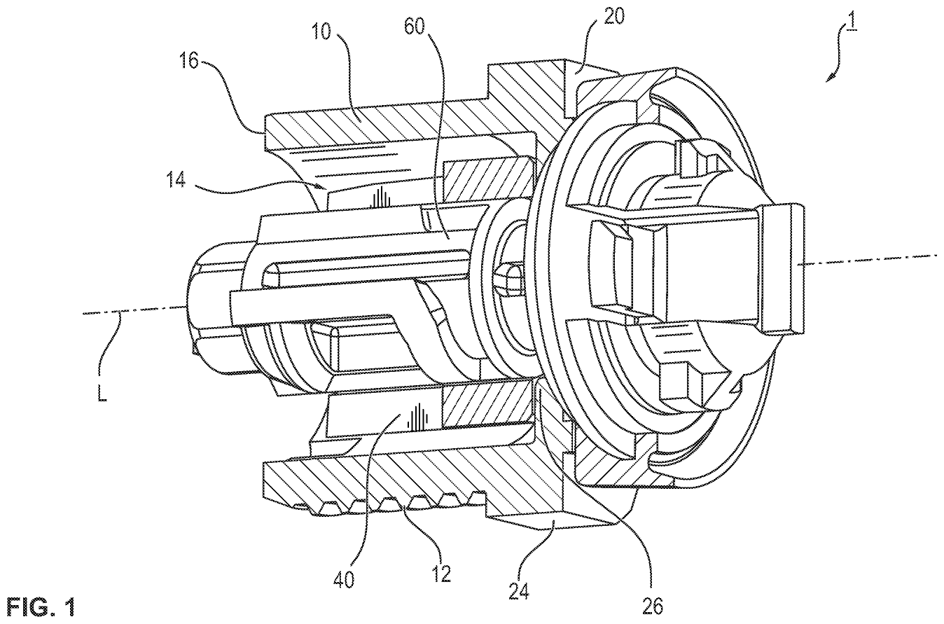

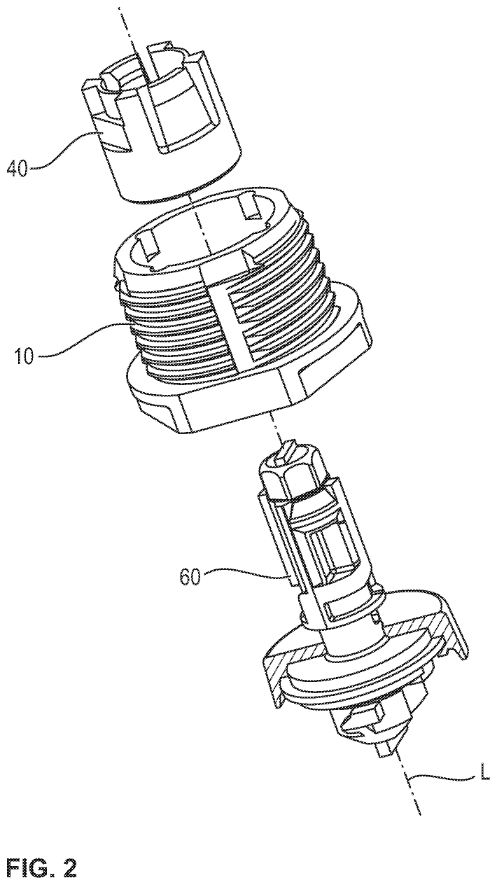

The present invention describes a connecting element 1, with which two components A, B are connected with one another (see FIG. 1, 12, 20, 21). The connecting element 1 maintains a defined distance between the two components A, B within the established connection. Furthermore, due to the construction, the connecting element 1 is capable of compensating present tolerances in the alignment of the components A, B to be connected with respect to one another to improve the quality, the reliability and the load-bearing capacity of the established connection. The connecting element 1, 101; 201; 301 enables an axial tolerance compensation in the direction of a longitudinal axis L of the hollow screw 10; 110; 210; 310 and a lateral tolerance compensation transverse with respect to the longitudinal axis L of the hollow screw 10; 110; 210; 310.

A first preferred embodiment of the connecting element 1 is shown in a perspective sectional view in FIG. 1. It is made of a sleeve-like hollow screw 10 with an outer thread 12 and an inner cavity 14.

The hollow screw 10 is screwed into an opening O of the first component A. To facilitate a fastening of the hollow screw 10 and thus of the connecting element 1 in the first component A, the thread 12 is configured as a self-cutting and/or self-grooving thread. It is also preferred to use other thread configurations which realize a suitable fastening in the opening O of the first component A.

Preferably, the self-cutting and/or self-grooving thread generates a rotation-locking effect which retains the hollow screw 10 in the opening O. Even if the hollow screw 10 is displaced in its axial position after the installation by means of further rotating, the self-cutting and/or self-grooving thread still guarantees a reliable retention of the hollow screw 10 in the opening O of the first component A.

The hollow screw 10 comprises a first opening 18 on a first axial end 16 which is big enough to insert a nut element 40 into the cavity 14 of the hollow screw 10. The nut element 40, which is described in more detail below, is preferably received in an almost co-axial orientation to the longitudinal axis L of the hollow screw 10 in the cavity 14.

A second opening 22 is provided at a second axial end 20 of the hollow screw 10. The second opening 22 is configured smaller in terms of its diameter than the first opening 18. The second opening 22 is decreased by means of a radially inwardly protruding radial collar 26, at which the nut element 40 is supported with a connecting bolt 60 (see below).

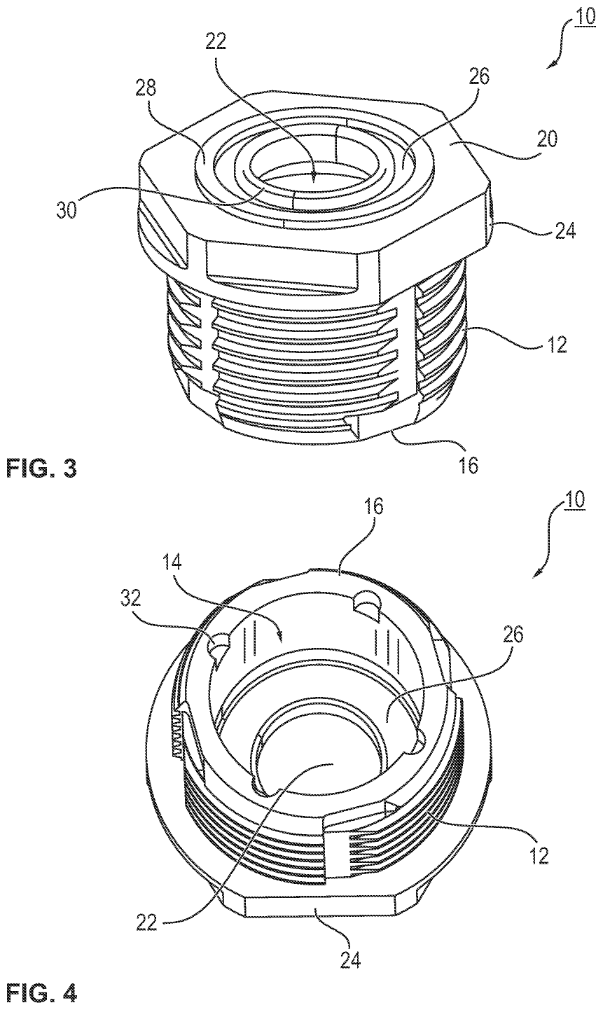

A preferred configuration of the hollow screw 10 is shown in more detail in a perspective view in FIGS. 3 and 4. An outer drive means 24 is preferably provided adjacent to or next to the second opening 22 of the hollow screw 10, in particular a polygon or hexagon. The drive means 24 serves for the transmission of a torque to the hollow screw 10 in order to screw it into the opening O of the first component A and fastening it with same.

The radial collar 26 preferably includes an attachment surface 28 for the connecting bolt 60 preferably at an axial outer side. The attachment surface 28 is preferably configured annular. It is also preferred to arrange this attachment surface having an angular configuration or several surface segments in regular arrangement around the second opening 22 of the hollow screw 10. The attachment surface 28 also preferably forms a contact surface with the connecting bolt 60 when same rests against or clamps at the radial collar 26 via the attachment surface 28 with the help of a connecting flange 62 in a force-fit connection with the nut element 40.

Furthermore, a circumferential embossing rip 30 is preferably arranged adjacent to the opening 22 at the first axial end 16. The embossing rip 30 preferably also projects beyond the attachment surface 28 in axial direction. It has a round or angular circumferential form.

The axially projecting embossing rip 30 is preferably pressed into or embossed in the force-fit connection between nut element 40 and connecting bolt 60 in a connecting flange 62 of the connecting bolt 60. A form-fit connection between the hollow screw 10 and the connecting flange 62 of the connecting bolt 60 is formed by that, supplementary to the force-fit connection between the nut element 40 and the connecting bolt 60. The form-fit connection serves for supporting and guaranteeing the radial position of nut element 40 and connecting bolt 60 with respect to the hollow screw 10. Furthermore, the form-fit connection preferably seals the connecting element 1 against media entering from the outside, e.g. by means of forming a labyrinth sealing.

According to a further preferred configuration of the present invention, the hollow screw 10 comprises a second drive means 32 adjacent to the first axial end 16. According to different preferred configurations, the drive means 32 is provided at the axial face side of the first axial end 16 or at the radial outside of the hollow screw 10 or at the radial inside of the cavity 14. Due to its arrangement, the drive means 32 enables an accessibility for a tool, even in an installed state of the connecting element 1 and when connecting two components. With the help of a preferred form fit between the tool and the drive means 32, a torque can be transmitted to the hollow screw 10 in order to change an axial position of the hollow screw 10 in the opening O of the first component A.

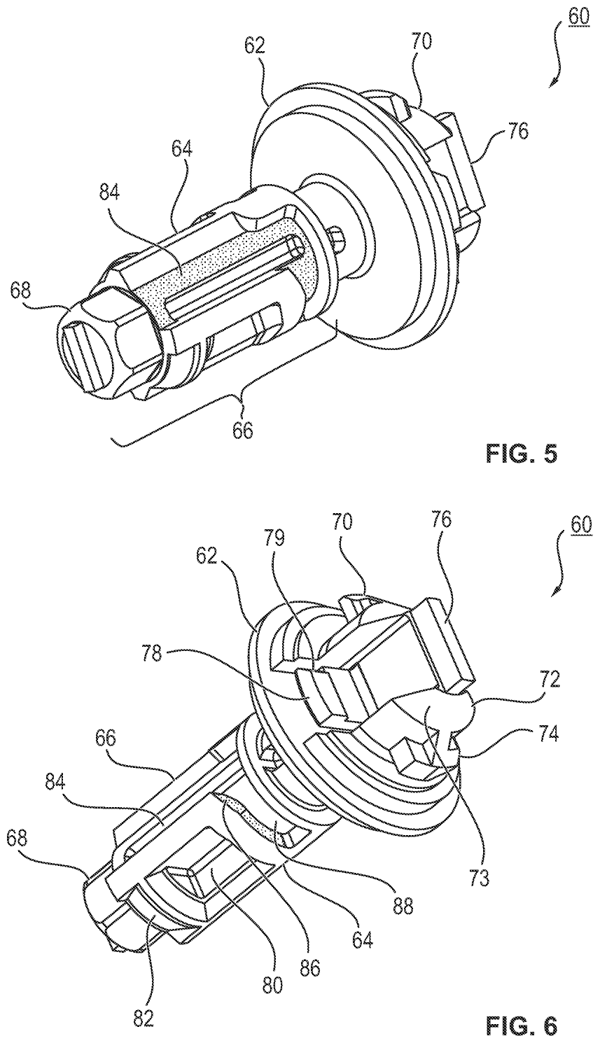

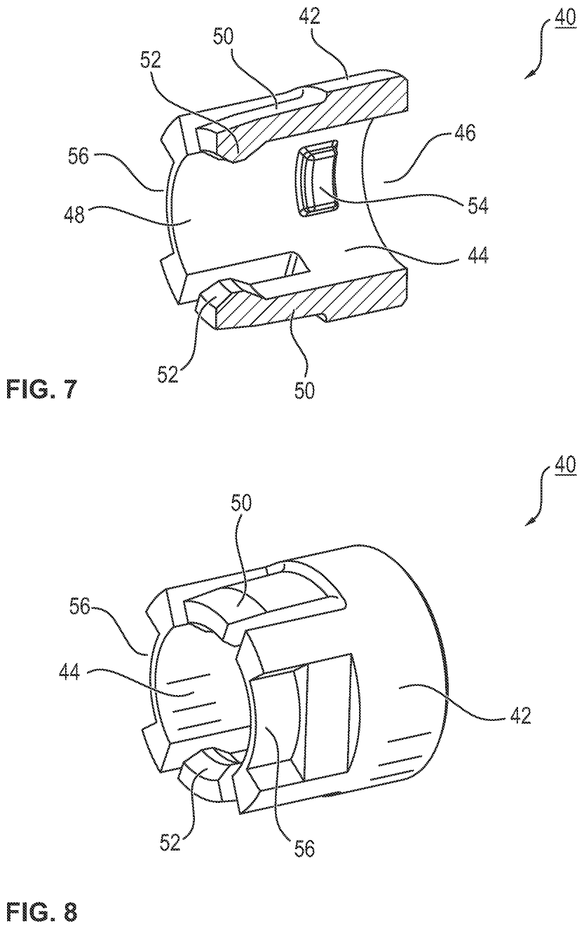

The connecting bolt 60 is shown in more detail in FIGS. 5 and 6 according to a first preferred embodiment of the present invention. The connecting bolt 60 is adapted so as to enter a preferably releasable connection with the preferred embodiment of the nut element 40 according to FIGS. 7 and 8.

The preferred connecting bolt 60 comprises a first axial connecting end 64 so as to enter into a form-fit and/or force-fit connection with the nut element 40.

Furthermore preferred, the interacting connecting surfaces of the nut element 40 and of the first connecting end 64 of the connecting bolt 60 are configured such that the connection between the connecting bolt 60 and the nut element 40 can be released in a non-destructive way.

The connecting surfaces of the first connecting end 64 of the connecting bolt 60 are arranged along a shaft 66 of the connecting bolt 60. In the connecting element 1, the shaft 66 is arranged in the cavity 14 of the hollow screw 10 and passes through the nut element 40 which is also arranged there.

The first connecting end 64 is limited in axial direction preferably by means of the radially extending connecting flange 62 which is arranged outside of the cavity 14 of the hollow screw 10. The first connecting end 64 furthermore ends in a drive means 68 so as to rotate the connecting bolt 60 by using same. Preferably, the drive means 68 is configured as a polygon, a slit, a web, a cross or an Allen key.

A second axial connecting end 70 is provided adjacent to the connecting flange 62 at the side of the connecting bolt 60 which faces away from the shaft. The second axial connecting end 70 is adapted to establish a connection, preferably a releasable connection, with the second component B.

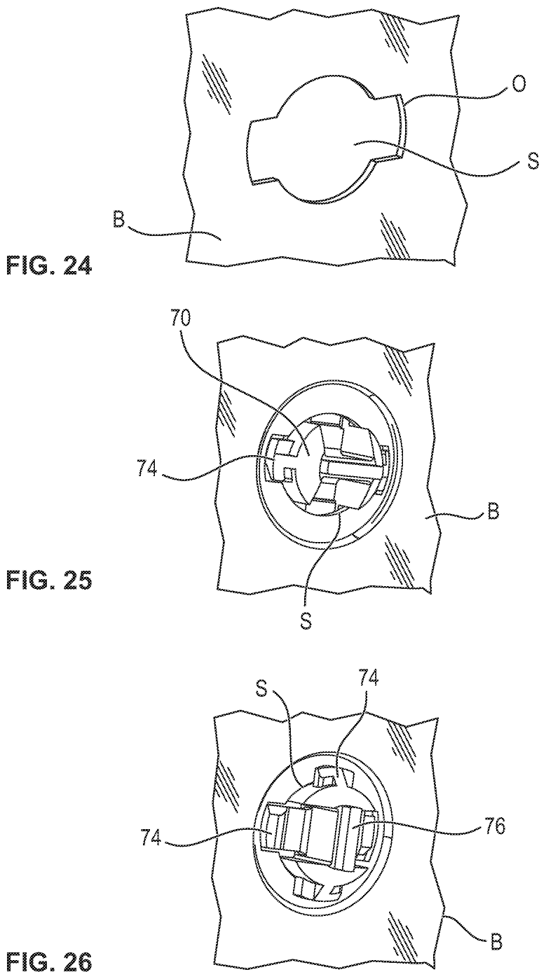

According to a preferred configuration of the second connecting end 70, same forms a quick lock with an opening O in the second component B. According to the invention, a bayonet connection is preferred so that the second connecting end 70 engages into a keyhole S (see FIG. 24) and locks there by means of a quarter turn. It is also preferred that the second connecting end 70 be configured as a threaded bolt or a thread shaft to fasten it with the help of a nut in the opening O of the second component B.

In the preferred configuration shown in FIG. 6, the second connecting end 70 includes a centering projection 72 having locking wings 74 being arranged opposite each other and projecting radially. The centering projection 72 comprises two centering planes 73 which are arranged opposite each other and are extending radially inwardly inclined to the free end of the centering projection 72. These centering planes 73 support an entering of the second connecting end 70 into the opening O of the second component B.

Furthermore preferred, an orientation web 76 is arranged at the centering projection 72 which shows the setting of the rotation angle of the connecting bolt 60 in relation to the keyhole S. A similar indication is preferably also located at the axial end of the first connecting end 64.

When inserting and locking the second connecting end 70 in the keyhole S of the second component B, the centering projection 72 is plugged through a central opening and the radially projecting locking wings 74 through radial recesses of the keyhole S (see FIG. 25). After that, the connecting bolt 60 is rotated preferably by means of the drive feature 68 around its longitudinal axis L until after a rotation by preferably 90°, at least one locking web 78, preferably two locking webs arranged opposite to each other, lock in the radial recesses of the keyhole S (see FIG. 26).

In order to support a preferred releasing of the locked locking webs 78, the locking web 78 is provided with a releasing ramp 79 on one side. The locking web 78 extends preferably along a partial circular arch around the longitudinal axis L of the connecting bolt 60. Accordingly, the releasing ramp 79 is arranged on one (see FIG. 6) or on both extension ends of the locking web 78. The connecting bolt 60 is rotated so that the releasing ramp 79 encounters a radial edge of a radial recess of the keyhole S. The releasing ramp 79 presses the locking web 78 out from the radial recess in axial direction due to the rotation, so that it is released and allows a further rotating of the connecting bolt 60.

The connecting bolt 60 is pre-installed in the hollow screw 10 and extends through the second opening 22 of the hollow screw 10 and is retained in the cavity 14 by means of the nut element 40.

According to a first preferred embodiment of the connecting element 1, the connecting bolt 60 is releasably connected with the nut element 40 according to FIGS. 5 and 6, preferred embodiments of the nut element being shown in FIGS. 7 and 8. The nut element 40 is constructed like a sleeve having a circumferential wall 42, an inner space 44 enclosed by the wall 42, an entry opening 46 and an exit opening 48.

According to a preferred configuration of the present invention, the circumferential wall 42 has at least two insertions for forming a locking arm 50 lying in between and extending in axial direction. It is furthermore preferred that the nut element 40 comprises two locking arms 50 which are extending radially inwardly and are arranged opposite one another.

The locking arms 50 comprise a radially inwardly projecting locking projection 52. The locking arm 50 with locking projection 52 preferably establishes a releasable snap connection or locking connection with the connecting bolt 60 as soon as the connecting bolt 60 is axially plugged into the nut element 40 arranged in the cavity 14 of the hollow screw 10. This preferred pre-fixing connection between the nut element 40 and the connecting bolt 60 guarantees a movement for positioning the connected parts in radial direction within the cavity 14 of the hollow screw 10. The outer boundary of the radial movability is determined by the inner diameter of the second opening 22 of the hollow screw 10.

In order to establish the preferred locking connection between the nut element 40 and the connecting bolt 60, the locking projection 52 preferably snaps into a recess 80 so as to pre-position the connecting bolt 60 at the nut element 40. To facilitate a reaching of the recess 80, the locking projection 52 slides into or to the recess 80 on a positioning ramp 82.

In the course of the pre-positioning or before assembling nut element 40 and connecting bolt 60 in the cavity 14, it is preferred that a guiding cam 54 of the nut element 40 engages a guide groove 84, which preferably extends in axial direction of the connecting bolt 60, at the shaft 66. Receiving the guiding cam 54 in the guide groove 84 causes a preferred relative axial guiding between nut element 40 and connecting bolt 60. Furthermore, nut element 40 and connecting bolt 60 are protected against rotating against each other. Accordingly, the form-fit connection between the guiding cam 54 and the guide groove 84 as well as between the locking projection 52 and the recess 80 acts individually or jointly as an anti-rotation protection between the nut element 40 and the connecting bolt 60.

First of all, the hollow screw 10 is screwed into the opening O in the component A. This is preferably carried out as a step of pre-positioning the connecting element 1 or as a first step in a connecting method of the two components A and B. At this point in time, the nut element 40 is already pre-assembled with the connecting bolt 60 in the cavity 14 of the hollow screw 10, i.e. it is not yet firmly connected. This means that the connecting bolt 60 and the nut element 40 are pre-fixed to one another via at least one locking connection (see above). This pre-fixation guarantees a radial and partly axial movability of the connecting bolt 60 in the cavity 14.

Then, the second connecting end 70 is preferably fastened in the opening O of the second component B. Preferably, the second axial connecting end 70 and the opening O form a quick lock or a bayonet lock in the second component B (see below).

From the connection of the hollow screw 10 with the first component A and the connecting bolt 60 with the second component B, the necessary radial position of the connecting bolt 60 within the second opening 22 of the hollow screw 10 preferably arises. According to that, a radial tolerance compensation was carried out, supported by the preferred loose connection between the nut element 40 and the locking bolt 60. This tolerance compensation has led to an adaption of the radial position of the connecting bolt 60 in the connecting element 1 to the alignment of the components A and B with respect to one another.

After the completed radial tolerance compensation, the radial position of the connection bolt 60 in the hollow screw 10 is preferably fixed. For this purpose, it is again preferred that a tool transmits a torque on the nut element 40 via a drive feature 56 in the circumferential wall 42 of the nut element 40, preferably a recess at the radial outer side of the nut element 40. The thus caused rotation of the nut element 40 on the shaft 66 of the connecting bolt 60 leads to the guiding cam 54 being guided over an insertion slope 86 into a fastening position 88 in the shaft 66 of the connecting bolt 60.

Due to the preferred rotation of the nut element 40, the guiding cam 54 is guided over the insertion slope 86 into the fastening position 88 at the connecting bolt 60. The movement of the guiding cam 54 leads to the connecting bolt 60 being displaced in axial direction towards the nut element 40 or into same, while the nut element 40 rests against the radial collar 26 in the cavity 14. Due to the axial movement of the connecting bolt 60 in the direction of the hollow screw 10, the nut element 40 and the connecting bolt 60 are fixedly clamped at the radial collar 26 of the hollow screw 10 via its connecting flange 62 or fixed in a friction-fit manner in a specific radial position with respect to the central longitudinal axis L of the hollow screw 10.

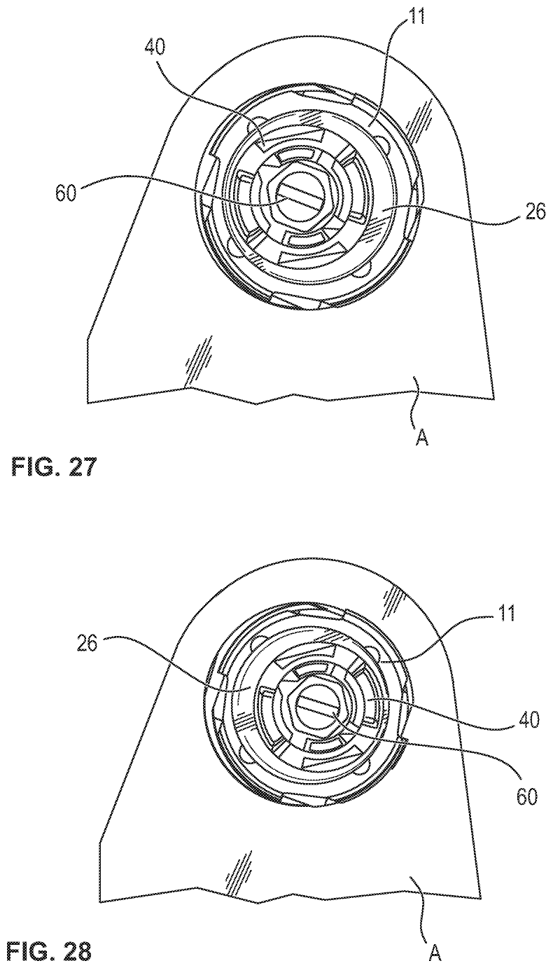

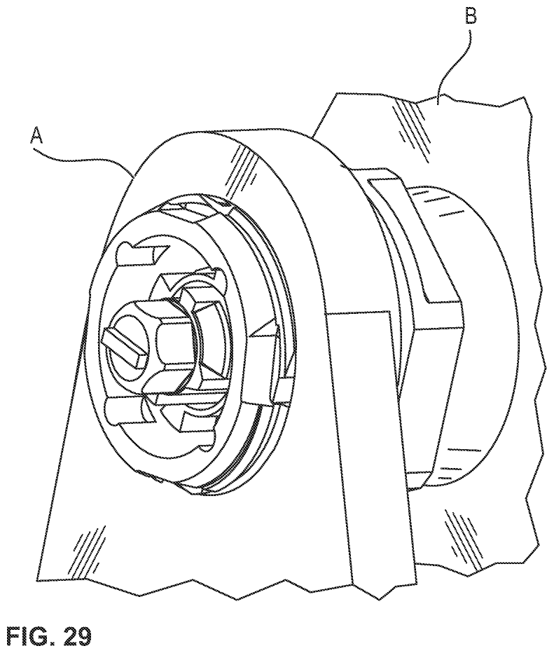

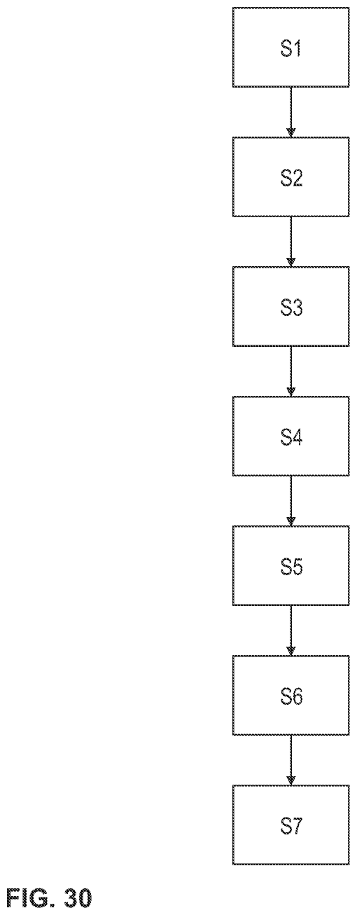

For demonstrating the different radial positions which can be assumed by the nut element 40 and the connecting bolt 60, reference is made to FIGS. 27 and 28. Compared to the circumferential wall 11 of the hollow screw 10, it can be recognized that the nut element 40 and the connecting bolt 60 are held in a friction-fit manner at different radial positions at the radial collar 26.

According to a preferred embodiment of the present invention, a sealing element 90 is provided at the connecting flange 62 of the connecting bolt 60. According to a preferred configuration of the present invention, the sealing element 90 has a cap-like or pot-like shape with a base area 92 and a circumferentially projecting wall 94. The opening of the sealing element 90, which is a result of the form features, is preferably oriented in the direction of the second connecting end 70 of the connecting bolt 60.

As the sealing element 90 is preferably made of an elastic material, it attaches itself to the component B in a sealing manner when entering into a connection with same, as is shown in FIGS. 10 and 17.

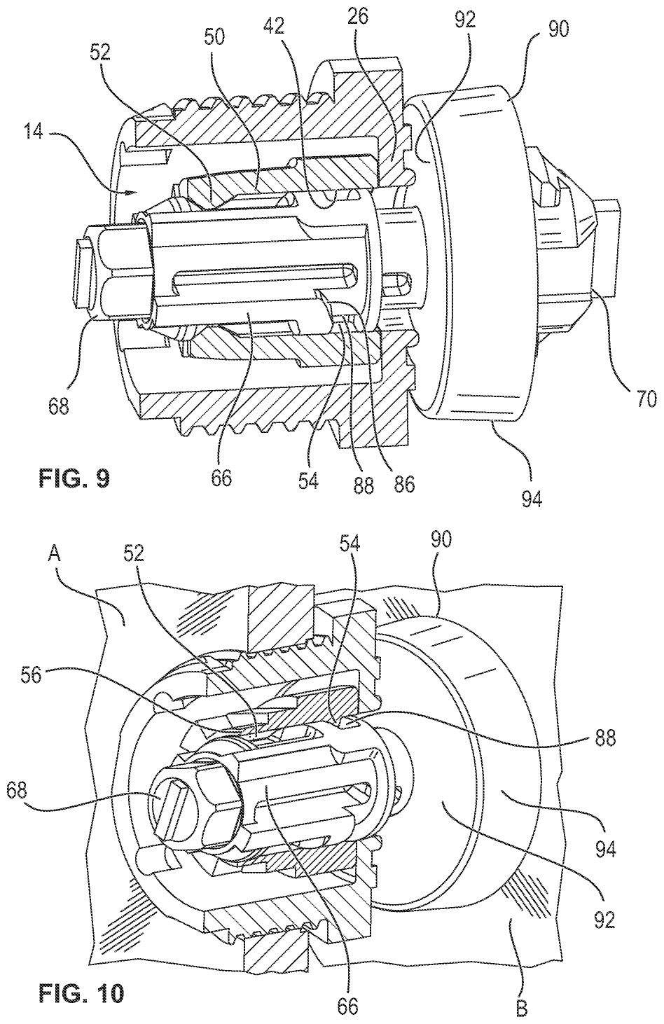

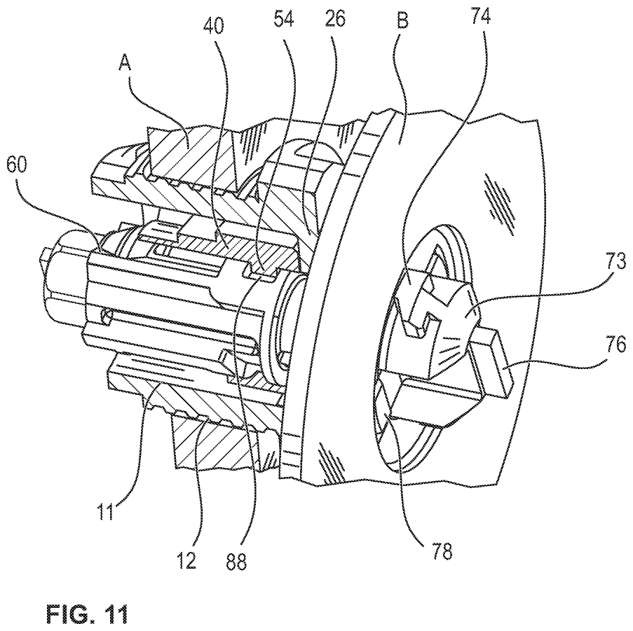

According to the preferred embodiment in FIGS. 9 and 10, the base area 92 is configured as an annular ring, the diameter of the inner opening of which is determined by the diameter of the shaft 66 of the connecting bolt 60. The size of the base area 92 has the advantage that the sealing element 90 is held in a friction-fit or force-fit manner between the connecting flange 62 and the adjacent attachment surface 28 of the hollow screw 10. This leads to the connecting element 1 being sealed to the outside.

For the preferred increase of the sealing effect, the hollow screw 10 comprises the embossing rip 30. The annular circumferential embossing rip 30 preferably projects beyond the attachment surface 28 at the second axial end 20. As soon as the sealing element 90 is pressed against the embossing rip 30, the embossing rip 30 deforms the sealing element 90, thus preferably forming kind of a labyrinth sealing.

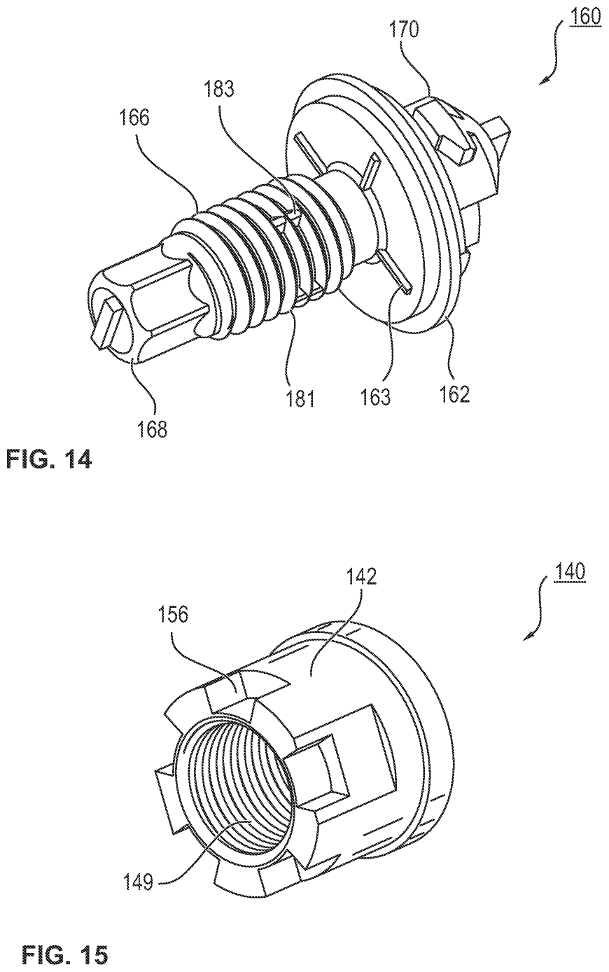

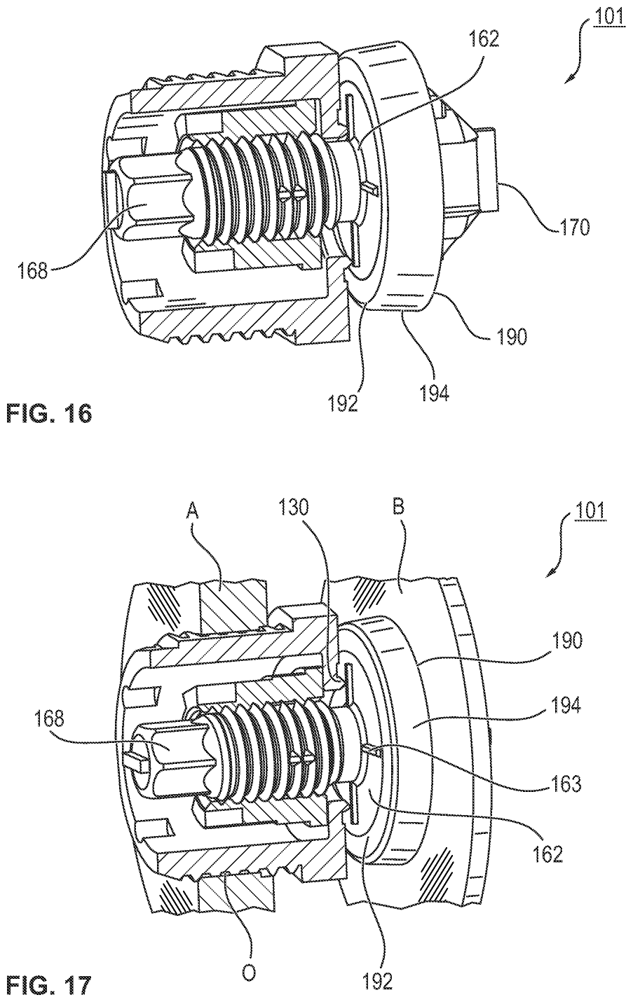

In the preferred configuration of the sealing element 190 according to FIG. 16, the annular ring of the base area 192 is reduced to a radially inwardly projecting retention collar. Due to this, a shaft-facing side of the connecting flange 62 of the force-fit connection is available at the radial collar 26. Preferably, the connecting flange 62 has radial rips 63 which in the friction-fit connection with the nut element 40 are embossed into the attachment surface 28 and/or the embossing rip 30. In this way, additional form-fit connections are formed which support the function of the connecting element 1.

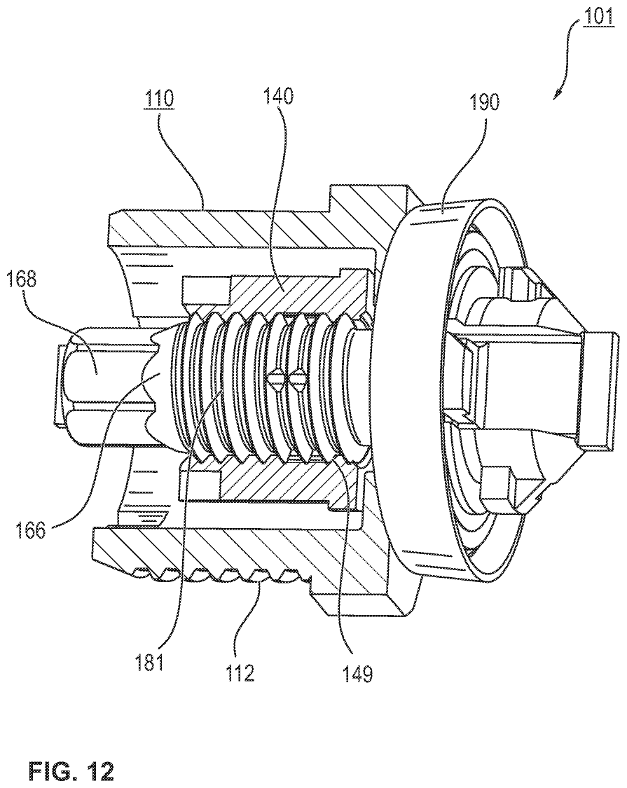

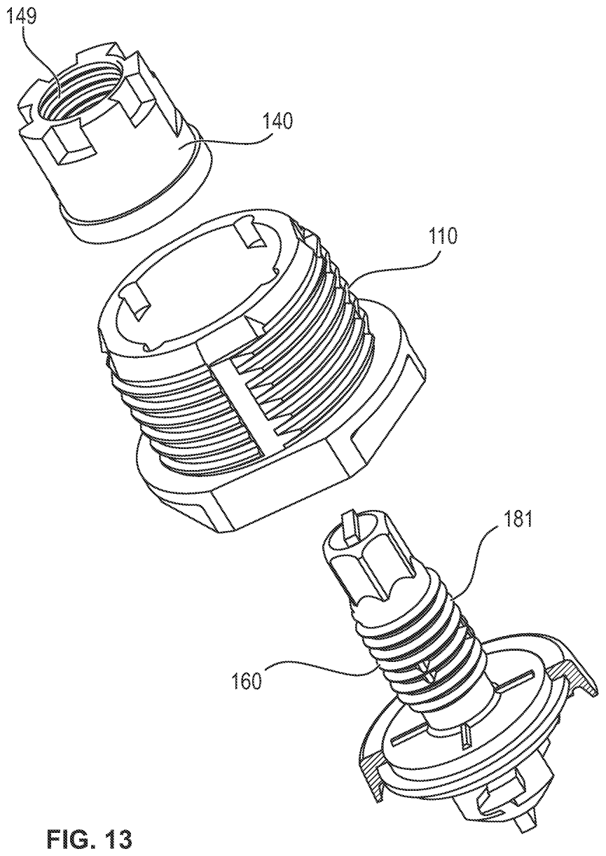

A perspective view of a further preferred embodiment of the connecting element 101 is shown in FIGS. 12 and 16. FIG. 13 shows the only three components of the connecting element 101 in a perspective explosion view, while in FIGS. 14 and 15, the connecting bolt 160 and the nut element 140 are individually illustrated.

Just like the connecting element 1 which is shown as an example in FIG. 1, the further preferred embodiment of FIG. 12 consists of only three components. There, the connecting bolt 60; 160 with sealing element 90; 190 is considered as one component. The use of only three components for providing the connecting element 1; 101 realizes a low manufacturing effort with regard to production effort and material effort as well as the assembly. Furthermore, the installation effort is preferably reduced by that as a connecting is limited to the hollow screw 10; 110 and the second connecting end 70; 170 of the connecting bolt 60; 160. This partial limitation and the associated advantages apply to all connecting elements 1; 101; 201; 301 described herein.

In contrast to the previously described connecting element 1, the shaft 166 of the connecting bolt 160 comprises an outer thread 181 and the nut element 140 comprises a matching inner thread 149. Accordingly, the nut element 140 and the connecting bolt 160 are connected with one another by means of rotation.

The rotation is applied in the known way by means of the drive feature 156 at the nut element 140 and/or by means of the drive feature 168 at the connecting bolt 160.

According to a preferred embodiment of the present invention, the outer thread 181 of the connecting bolt 160 includes at least one locking rip 183 for the thread lock. Preferably, for the pre-positioning or loose arrangement of the connection of nut element 140 and connecting bolt 160 in the hollow screw 110, the nut element 140 is screwed on the outer thread 181 of the shaft 166. The nut element 140 is screwed-on only to the extent that the inner thread 149 does not yet reach the locking rip 183. On this basis, the nut element 140 is still axially positionable and radially along with the connecting bolt 160 in the hollow screw 110.

In order to fasten the connecting bolt 160 in a specific radial position at the radial collar 126 of the hollow screw 110, the nut element 140 is completely screwed on the outer thread 181. In this way, the connecting flange 162 and the nut element 140 clamp the radial collar 126 in a friction-fit or force-fit manner, respectively, between them, as is shown in FIG. 17. At the same time, the selected radial position of the connecting bolt 160 is fixed by that, as is shown in FIGS. 27, 28. The locking rip 183 also preferably prevents a releasing of the thread connection between nut element 140 and connecting bolt 160, when no minimum torque for overcoming the thread inhibition is applied.

Preferably, FIGS. 16 and 17 emphasize the installation process of the connecting element 101 which was already described above. After the pre-positioning of the connection of nut element 140 and connecting bolt 160 in the hollow screw 110, the hollow screw 110 is screwed into the opening O of the first component A.

In the following, the movable connection of nut element 140 and connecting bolt 160 is preferably positioned in a radially suitable way, so that the second axial connecting end 170 of the connecting bolt 116 is aligned to the preferred keyhole S of the second component B.

By means of the preferred rotation of the connecting bolt 160 via the drive means 168, the second connecting end 170 is fastened in the keyhole S.

After that, it is also preferred that with the help of a tool, a torque is transmitted to the nut element 140 by means of a suitable form fit with the drive feature 156 at the nut element 140. The rotation of the nut element 140 screws the inner thread 149 further on the outer thread 166 of the connecting bolt 160. The process of screwing-on is concluded with an effective friction-fit connection or clamping of the connecting flange 162 and nut element 140 at the circumferential radial collar 126 of the hollow screw 110. It is similarly preferred that during this process, the radial rips 163 of the connecting flange 162 are pressed into the embossing rip 130 in order to achieve an additional form fit.

The sealing element 190 attaches to the component B already during the connecting of the second connecting end 170 with the second component B.

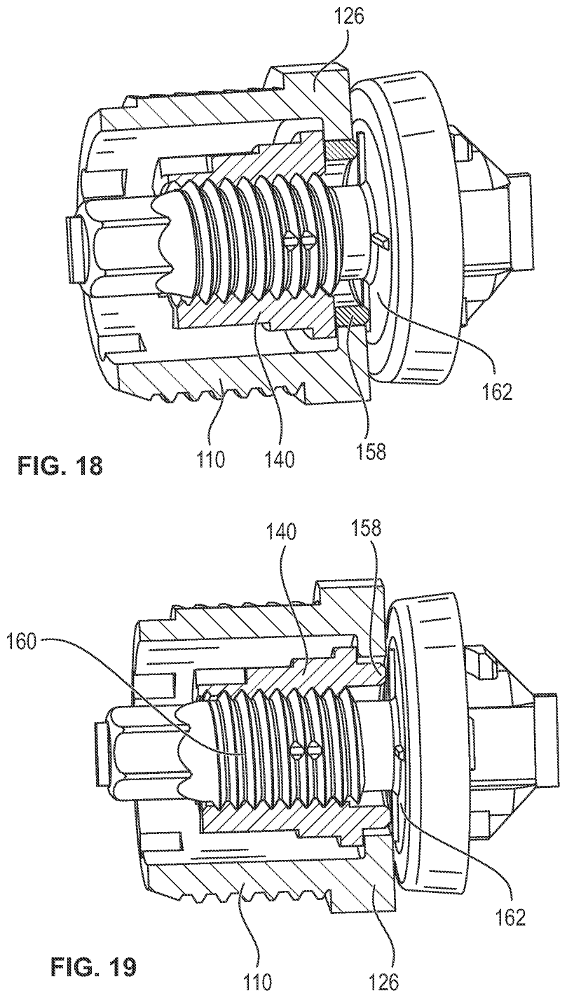

According to a preferred further development of the connecting element 101, the nut element 140 is equipped with an axially projecting compression limiter 158. When in an annular shape, the compression limiter 158 projects from the nut element 140 in the direction of the connecting flange 162. According to different preferred configurations, the compression limiter 158 is provided as an individual part (see FIG. 18) or integrated into the nut element 140 (see FIG. 19).

Due to the axial projection of the compression limiter 158 in the direction of the connecting flange 162, the connecting flange 162 is preferably screwed on-block with the compression limiter 158. This screwing on-block limits the intensity of the clamping of the radial collar 126 of the hollow screw 110 between the nut element 140 and the connecting flange 162.

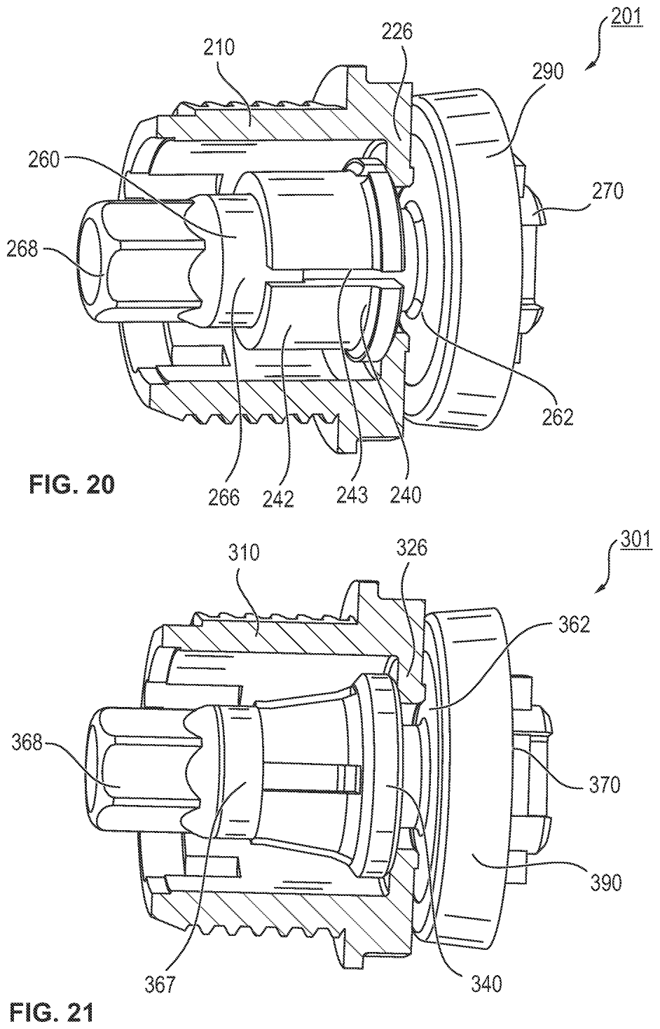

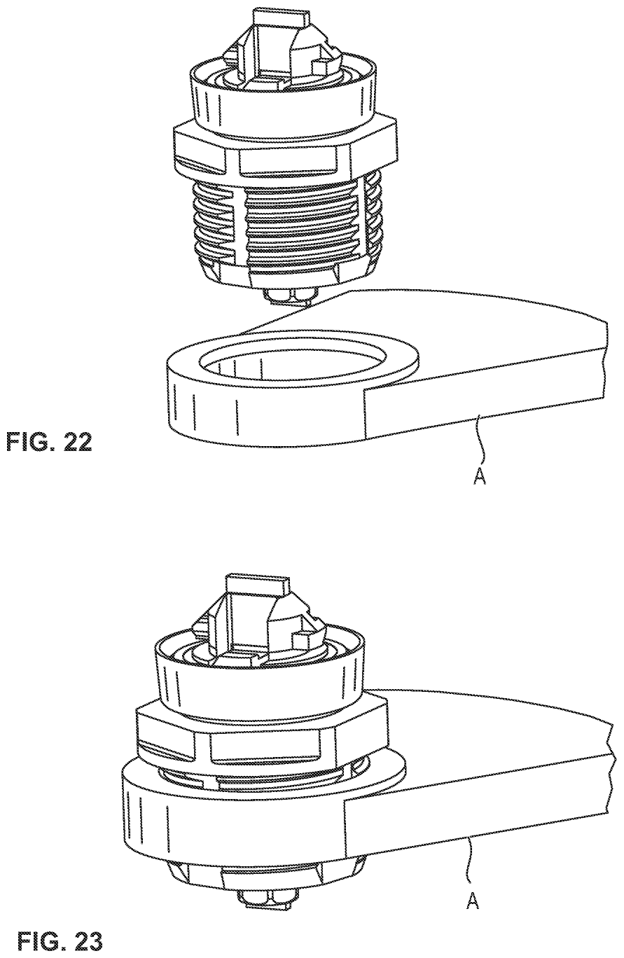

A further preferred embodiment of the connecting element 201 is shown in FIG. 20. In contrast to the above-described embodiment 1; 101, the nut element 240 is fastened on the shaft 266 of the connecting bolt 260 in a non-releasable manner. For this purpose, the nut element 240 is configured like an explosion ring. Accordingly, an inner diameter of the nut element 240 is smaller than an outer diameter of the shaft 266 of the connecting bolt 260.

The nut element 240 comprises an axially continuous gap 243 in the wall 242. By that, the diameter of the almost annularly bent wall 242 can by widened in order to clamp the nut element 240 onto the shaft 266. The friction-fit connection which is achieved by that between the shaft 266 and the nut element 240 guarantees the likewise friction-fit or force-fit connection between the connecting flange 262 and the nut element 240 at the radial collar 226 of the hollow screw 210.

In order to connect the components A, B with each other by means of the connecting element 201, the hollow screw 210 is screwed into the component A in a first step (step S1). The nut element 240 and the connecting bolt 260 are loosely connected with each other in the cavity 214 of the hollow screw 210.

By rotating of the connecting bolt 260 via the drive means 268, the second connecting end 270 is fastened in the second component B (step S2).

In the meantime, the suitable radial position of the connecting bolt 260 could be adjusted in alignment with the connected components A, B. In order to fix the selected radial position by means of clamping at the radial collar 226 of the hollow screw 210 (step S3), the nut element 240 is shifted with a suitable tool on the shaft 266 to the maximum extent in the direction of the connecting flange 262, based on its configuration like a clamping ring. Due to the clamping configuration, the nut element 242 maintains the friction-fit connection with the connecting bolt 260 in the radial position at the radial collar 226 and thereby preferably also fixes the radial position of nut element 240 and connecting bolt 260 in the cavity 214.

A further preferred embodiment of the connecting element 301 is shown in FIG. 21. The nut element 340 is configured as a non-releasable locking ring structure, similar as the configuration of the connecting element 201. Accordingly, the nut element 340 comprises a circumferential ring 341 with a plurality of locking webs 345 extending from it in axial direction. The locking webs 345 extend in the direction of the drive feature 368 and rest against a locking projection 367 which is provided circumferentially around the shaft 366. The installation of the connecting element 301 takes place analogously to the above-described installation of the connecting element 201.

The connecting method of the first A and the second component B at a defined distance to one another, which was already described above for the different preferred configurations of the connecting element 1; 101; 201; 301 can be summarized with the following steps. In a first step S1, a screwing-in of the hollow screw 10; 110; 210; 310 of the connecting element 1; 101; 201; 301 into the first fastening opening O at the first component A takes place. After that, the second connecting end 70; 170; 270; 370 of the connecting bolt 60; 160; 260; 360 is fastened in a second fastening opening S of the second component B, with radial tolerances being compensated in an axial alignment of the hollow screw 10; 110; 210; 310 and the connecting bolt 60; 160; 260; 360. In a further step, the nut element 40; 140; 240; 340 and the first connecting end 64; 164; 264; 364 of the connecting bolt 60; 160; 260; 360 are firmly connected with each other so that the connecting bolt 60; 160; 260; 360 is fastened at the hollow screw 10; 110; 210; 310.

According to a further preferred configuration of the installation method, the hollow screw 10; 110; 210; 310 is rotated in the first component A so as to adjust an axial position of the connecting element 1; 101; 201; 301.

According to a further preferred embodiment of the connecting method, the nut element 40; 140; 240; 340 is released within the hollow screw 10; 110; 210; 310, after that, a radial position of the connecting bolt 60; 160; 260; 360 compared to the hollow screw 10; 110; 210; 310 is changed and then, the nut element 40; 140; 240; 340 is again fastened at the connecting bolt 60; 160; 260; 360.

### 6. LIST OF REFERENCE SIGNS

1, 101, 201, 301 connecting flange
10, 110, 210, 310 hollow screw
11 circumferential wall
12 outer thread
14 cavity
16 first axial end of the hollow screw
18 first opening of the hollow screw
20 second axial end of the hollow screw
22 second opening of the hollow screw
24 drive means
26 radial collar
28 attachment surface
30 embossing rip
32 second drive means
40; 140; 240; 340 nut element
42; 242 circumferential wall
44 inner space
46 entry opening
48 exit opening
50 locking arm
52 locking projection
54 guiding cam
56 drive feature
60; 160; 260; 360 connecting bolt
62 connecting flange
63 radial rips
64 first axial connecting end
66 shaft
68 drive means
70 second axial connecting end
72 centering projection
73 centering plane
74 radially projecting locking wings
76 orientation web
78 locking web
79 releasing ramp
80 recess for pre-positioning
82 positioning ramp
84 guiding groove
86 insertion slope at the shaft
88 fastening position of the guiding cam 54 at the shaft
90 sealing element
92 base area
94 circumferential wall of the sealing element
181 outer thread of the shaft 166
149 inner thread of the nut element 140
183 locking rip
158 compression limiter
243 gap
261 locking edge
341 circumferential ring
345 locking web
367 locking projection
A, B components
L longitudinal axis
O opening in the second component
O opening in the first component
S keyhole

1. A connecting element of two components spaced apart one another with tolerance compensation function comprising:
a. a hollow screw with an outer thread, with which a thread connection to a first component is establishable, which is adjustable by means of at least one drive means of the hollow screw in its longitudinal direction,
b. a nut element which is received in a receiving space of the hollow screw and which comprises a radial inner functional surface so that a form-fit and force-fit connection is establishable with a first connecting end of a connecting bolt, wherein
c. the connecting bolt has a second connecting end, with which a connection to a second component is establishable.

2. The connecting element according to claim 1, in which a first opening of the hollow screw has an opening diameter which is larger than a bolt diameter of the connecting bolt which reaches into the hollow screw, so that the connecting bolt is displaceable within the first opening of the hollow screw for compensating tolerances laterally with respect to its longitudinal axis.

3. The connecting element according to claim 2, in which the hollow screw has a radial collar at the first opening reaching into the first opening, to which radial collar the nut element and the connecting bolt are fastenable by means of a joint connection so as to fix a radial position of the connecting bolt within the first opening.

4. The connecting element according to claim 2, in which the connecting bolt comprises a radially outwardly projecting connecting flange between the first connecting end and the second connecting end, the connecting flange supporting a force-fit connection with the hollow screw.

5. The connecting element, according to claim 16, in which the connecting flange comprises webs facing the hollow screw which support a connection between the hollow screw and the connecting bolt in a form-fit manner.

6. The connecting element according to claim 16, in which the connecting flange comprises a cap-like sealing element projecting in the direction of the second connecting end so as to seal a connection to a second component.

7. The connecting element according to claim 1, in which the connecting bolt includes a drive means adjacent to the first connecting end.

8. The connecting element according to claim 1, in which the radial inner functional surface of the nut element and the first connecting end of the connecting bolt form a quick lock.

9. The connecting element according to claim 1, in which the first connecting end of the connecting bolt comprises an outer thread and the nut element comprises a matching inner thread for establishing a thread connection.

10. The connecting element according to claim 1, in which the second connecting end of the connecting bolt forms a quick lock with a connecting opening in a second component.

11. The connecting element according to claim 1, in which the hollow screw includes a first drive means and a second drive means which are arranged adjacent to the opposite axial ends.

12. A connection of a first component and a second component spaced apart one another with the connecting element according to claim 1.

13. A connecting method of a first component and a second component at a distance to one another with the connecting element according to claim 1, comprising:
a. screwing-in the hollow screw of the connecting element into a first fastening opening at the first component,
b. fastening the second connecting end of the connecting bolt in a second fastening opening of the second component, with radial tolerances being compensated in an axial alignment of the hollow screw and the connecting bolt,
c. connecting the nut element and the first connecting end of the connecting bolt so that the connecting bolt is fastened to the hollow screw.

14. The connecting method according to claim 13 further comprising:
d. rotating the hollow screw in the first component so as to adjust an axial position of the connecting element.

15. The connecting method according to claim 13, further comprising:
releasing the nut element within the hollow screw,
changing a radial position of the connecting bolt compared with the hollow screw and
after that, fastening the nut element at the connecting bolt.

16. The connecting element according to claim 1, in which the connecting bolt comprises a radially outwardly projecting connecting flange between the first connecting end and the second connecting end, the connecting flange supporting a force-fit connection with the hollow screw.

17. The connecting element according to claim 5, in which the connecting flange comprises a cap-like sealing element projecting in the direction of the second connecting end so as to seal a connection to a second component.

18. The connecting element according to claim 2, in which the connecting bolt includes a drive means adjacent to the first connecting end.

19. The connecting element according to claim 2, in which the radial inner functional surface of the nut element and the first connecting end of the connecting bolt form a quick lock.

20. The connecting method according to claim 14, further comprising:
releasing the nut element within the hollow screw,
changing a radial position of the connecting bolt compared with the hollow screw, and
after that, fastening the nut element at the connecting bolt.
